(19) United States
(12) Patent Application Publication
(10) Pub. No.: US 2003/0209895 A1
(43) Pub. Date: Nov. 13, 2003

(54) Airbag and airbag apparatus

(75) Inventor: Weixin Gu, Echi-gun (JP)

Correspondence Address: KANESAKA AND TAKEUCHI, 1423 Powhatan Street, Alexandria, VA, 22314, US

(73) Assignee: TAKATA CORPORATION

(21) Appl. No.: 10/413,133

(22) Filed: Apr. 15, 2003

(30) Foreign Application Priority Data
May 10, 2002 (JP) 2002-135613

(51) Int. Cl. B60R 21/28

(52) U.S. Cl. 280/739

(57) ABSTRACT

An airbag includes a bag section having a front portion facing an occupant and a rear portion at a side opposite to the front portion when the airbag is inflated. The rear portion has a vent hole. One end of a nozzle having a hollow body is connected to a peripheral edge of the vent hole. The nozzle is arranged inside the bag section when the bag section is folded. The nozzle projects outside the bag section through the vent hole when the bag section is inflated.

### BACKGROUND OF THE INVENTION AND RELATED ART STATEMENT

The present invention relates to an airbag of an airbag apparatus installed in a vehicle such as an automobile and, more particularly, relates to an airbag having a vent hole.

In an airbag apparatus for an automobile, an inflator is actuated in case of emergency such as a vehicle collision or rollover so that an airbag is inflated with gas spouted from the inflator for protecting an occupant.

When the airbag is provided with a vent hole(s), gas within the airbag flows out through the vent hole when the occupant plunges into the inflated airbag so as to absorb an impact on the occupant.

Japanese Patent Publication (KOKAI) No. 08-268213 has disclosed an airbag comprising two fabric sheets superposed with each other and then sewn together along their peripheries to form a bag shape. The two fabric sheets have tongue portions, and tubular vent holes formed by sewing the tongue portions together along their sides. As described in the publication, the tubular vent holes are pressed against an inner surface of the airbag to prevent the gas from flowing through the vent holes in an initial stage of the airbag inflation, thereby ensuring an inner pressure of the airbag.

The airbag disclosed in the publication has a problem that the gas flowing out through the vent holes is discharged in lateral directions directly toward the occupant.

Japanese Patent Publication (KOKAI) No. 2000-52916 has disclosed an improved airbag having a vent hole for allowing the gas to flow through the vent hole toward a rear direction, thereby dispersing over a wide range.

The airbag disclosed in Japanese Patent Publication No. 2000-52916 is provided with a nozzle extending outwardly from a periphery of the vent hole for preventing the gas through the vent hole from blowing intensively toward a certain portion. In the nozzle, a ratio between a length L and a diameter D thereof, i.e. L/D, is set in a range form 0.5 to 3. According to the airbag, the nozzle tends to wag just like a dog tail when the gas flows out through the vent hole so that the gas disperses in various directions, thereby preventing the gas from blowing intensively toward a certain portion.

According to the airbag disclosed in Japanese Patent Publication No. 2000-52916, the nozzle becomes cylindrical because of the gas pressure when the inner pressure of the airbag increases, so that the gas can smoothly flow out from the vent hole through the nozzle. A relatively high-output inflator is required for ensuring the inner pressure of the airbag, thereby increasing a cost.

It is an object of the present invention to provide an airbag in which the initial inner pressure of the airbag can be ensured even with a low-output inflator and the gas flowing through a vent hole can be directed to disperse toward a rear direction.

It is another object of the present invention to provide an airbag apparatus provided with such an airbag.

Further objects and advantages of the invention will be apparent form the following description of the invention.

### SUMMARY OF THE INVENTION

According to the present invention, an airbag to be inflated in front of a vehicle occupant includes a vent hole formed in a rear surface opposite to a surface facing a vehicle occupant and a nozzle with one end thereof connected to a peripheral edge of the vent hole. The nozzle is arranged inside the airbag when the airbag is in a folded state, and is forced out by a gas pressure in the airbag to project outside through the vent hole during the inflation of the airbag.

An airbag apparatus of the present invention comprises such an airbag and an inflator for inflating the airbag.

According to the airbag and the airbag apparatus of the present invention, the nozzle is arranged inside the airbag and is thus pressed against an inner surface of the airbag by the gas pressure when the airbag is inflated upon the actuation of the inflator. Therefore, the vent hole is closed, thereby ensuring the initial inner pressure of the airbag. As the inner pressure of the airbag exceeds a predetermined value, the nozzle is forced out of the airbag through the vent hole and increases its diameter to open into a cylindrical shape, so that the gas flows out of the airbag through the nozzle from the vent hole. Accordingly, the impact on the occupant plunging into the airbag is absorbed.

According to the present invention, a coefficient of friction between an outer surface of the nozzle and an inner surface of the airbag may be larger than a coefficient of friction between inner surfaces of the nozzle. In this case, even when the initial inner pressure is exerted to the nozzle, the nozzle is exploded out through the vent hole more slowly, thereby delaying the nozzle to open and obtaining a higher initial inner pressure.

The present invention can be applied to various airbags such as a driver airbag, a front passenger airbag, a rear passenger airbag, and a side airbag.

### BRIEF DESCRIPTION OF THE DRAWINGS

FIG. 1 is a perspective view of an airbag according to an embodiment in an inflated state; and

FIGS. 2(a) and 2(b) are sectional views taken along line 2-2 in FIG. 1, wherein FIG. 2(a) shows a state before the airbag is inflated, and FIG. 2(b) shows a state after the airbag is inflated.

### PREFERRED EMBODIMENTS OF THE INVENTION

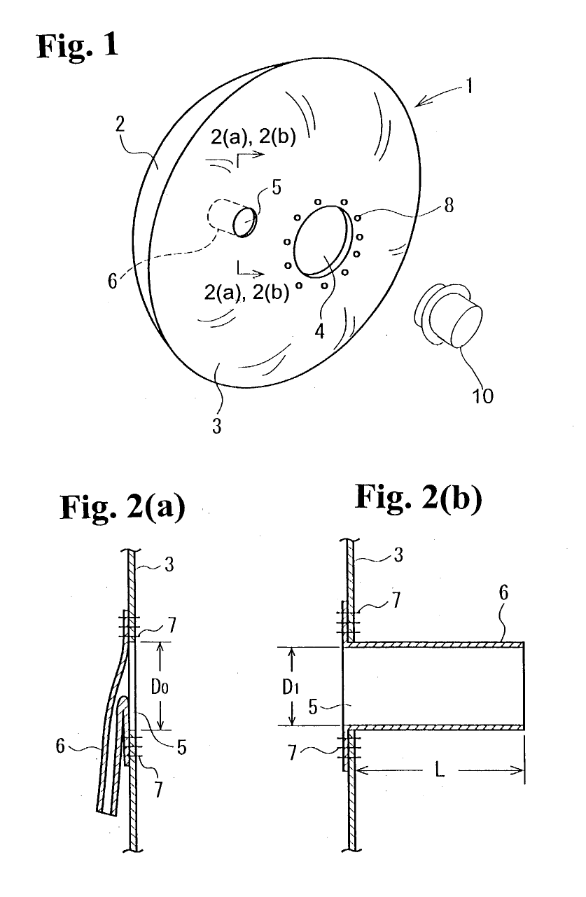

Hereinafter, embodiments of the present invention will be described with reference to the accompanying drawings. FIG. 1 is a perspective view of an airbag according to an embodiment in an inflated state. FIGS. 2(a) and 2(b) are sectional views taken along line 2-2 in FIG. 1, wherein FIG. 2(a) shows a state before the airbag is inflated, and FIG. 2(b) shows a state after the airbag is inflated.

An airbag 1 used for a driver airbag apparatus comprises a circular front panel 2 and a circular rear panel 3 superposed with each other and sewn together along their peripheries. The rear panel 3 is provided with a central opening 4 through which an inflator is inserted. The rear panel 3 is also provided with a vent hole 5. A nozzle 6 formed of a fabric has a cylindrical shape, and is fixed to a periphery of the vent hole 5 by sewing. A reference numeral 7 in FIGS. 2(a) and 2(b) designates sewing yearns for attaching the nozzle 6 to the rear panel 3.

In the airbag 1, a periphery of the central opening 4 is attached to a retainer (not shown) of the driver airbag apparatus, so that an inflator 10 attached to the retainer is inserted through the central opening 4. A reference numeral 8 designates through holes for bolts or screws for fixing the airbag 1 and the inflator to the retainer. The airbag 1 is folded in a state that the nozzle is arranged inside the airbag 1 and is covered by a module cover, thereby constituting the airbag apparatus.

In case of emergency such as a vehicle collision, the inflator is actuated to inflate the airbag 1. Upon the actuation, a part of the module cover is torn to open so that the airbag 1 is expanded into the vehicle cabin.

In the initial stage of inflation of the airbag 1, the nozzle 6 blocks the vent hole 5, and the nozzle 6 is pressed against an inner surface of the airbag 1 because of a gas pressure. Therefore, the vent hole 5 is kept closed for a while after the activation of the inflator, thereby rapidly increasing the inner pressure of the airbag 1. As the inner pressure of the airbag 1 exceeds a predetermined value, the nozzle 6 is pressed by the gas pressure to be forced out through the vent hole 5. Accordingly, the nozzle 6 becomes a cylindrical shape as shown in FIG. 2(b), and the vent hole 5 becomes therefore an open state.

As the vehicle occupant plunges into the inflated airbag 1, the gas in the airbag flows out through the vent hole 5 and the nozzle 6, thereby absorbing the impact, on the occupant. The nozzle 6 wags intensely when the gas in the airbag 1 flows out through the nozzle 6. Thus, the gas spreads over a wide range, thereby preventing the gas from blowing toward a certain portion for a long period of time.

It is preferable that a diameter D0 of the vent hole 5, a diameter D1 of the nozzle 6, and a length L of the nozzle 6 are set such that D1/D0 is equal to or greater than 1, and L/D0 is greater than 1 and is equal to or less than 10. A closing period of the vent hole 5 in an initial stage depends on values of D0, D1, and L. The closing period of the vent hole 5 at an initial stage also depends on a coefficient of friction between an outer surface of the nozzle 6 and an inner surface of the airbag 1. A larger coefficient of friction results in a longer period of the closing period.

It is preferable that the fabric material of the nozzle 6 is made of the same as or similar to that of the front panel 2 and the rear panel 3. The nozzle 6 may be made of other fabric material or a synthetic resin sheet.

When the nozzle 6 is made of a fabric similar to the fabric of the front panel 2, and the fabric is a woven fabric coated with a soft rubber such as a silicone rubber or chloroprene rubber, the nozzle 6 is formed so that the surface coated with the soft rubber becomes the outer surface thereof. Accordingly, the outer surface of the nozzle 6 is the rubber-coated surface so as to increase the coefficient of friction between the outer surface of the nozzle 6 and the inner surface of the airbag 1, thereby prolonging the closing time period of the airbag 5 in the initial stage without increasing the length of the nozzle 6.

When the nozzle 6 has a relatively short length, the nozzle 6 does not disturb a process of folding the airbag 1, thereby improving the workability of the process of the airbag 1. In addition, when the nozzle 6 has a relatively short length, the closing time period of the vent hole 5 in the initial stage does not vary due to twist of the nozzle 6, thereby securely ensuring the closing time period in the initial stage according to the design.

The aforementioned embodiment is just an example of the present invention, and the present invention may use forms other than the illustrated examples. The nozzle 6 is superposed on the inner surface of the airbag 1 and sewn together as shown in FIGS. 2(a) and 2(b). Alternatively, for example, the nozzle 6 may be superposed on the outer surface of the airbag 1 and sewn together. Instead of the sewing, other connecting means such as adhesion may be employed. The number of vent holes may be two or more. When the airbag has two or more vent holes, lengths of the nozzles for the respective vent holes may be equal to each other or different from each other. By designing the nozzles with different lengths, the inner pressure of the airbag can be controlled with time.

When the airbag has two nozzles, the nozzles are arranged inside the airbag such that an end of one nozzle is inserted into an end of the other nozzle.

As described above, according to the airbag and the airbag apparatus of the present invention, the inner pressure of the airbag in the initial stage of the inflation can be ensured even with a low-output inflator. In addition, the gas flowing out from the vent hole can be dispersed over a wide range, thereby preventing the gas from blowing intensively toward a certain portion.

While the invention has been explained with reference to the specific embodiments of the invention, the explanation is illustrative and the invention is limited only by the appended claims.

What is claimed is:

1. An airbag to be inflated in front of an occupant, comprising:
a bag section having a front portion facing the occupant and a rear portion at a side opposite to the front portion when the airbag is inflated, said rear portion having a vent hole, and
a nozzle having a hollow body with one end connected to a peripheral edge of the vent hole, said nozzle being arranged inside the bag section when the bag section is folded so that when the bag section is inflated, the nozzle projects outside the bag section through the vent hole.

2. An airbag according to claim 1, wherein said nozzle has an outer surface with a coefficient of friction relative to an inner surface of the bag section larger than a coefficient of friction between inner surfaces of the nozzle.

3. An airbag according to claim 1, wherein said vent hole has a diameter D0, and said nozzle has a diameter D1 and a length L so that D1/D0 is equal to or greater than 1, and L/D0 is greater than 1 and is equal to or less than 10.

4. An airbag apparatus comprising the airbag according to claim 1, and an inflator for inflating the airbag.
